(19) United States
(12) Patent Application Publication
(10) Pub. No.: US 2025/0116790 A1
(43) Pub. Date: Apr. 10, 2025

(54) SYSTEM AND METHOD FOR PROCESSING DISTRIBUTED ACOUSTIC SENSING SEISMIC DATA

(71) Applicant: Chevron U.S.A. Inc., San Ramon, CA (US)

(72) Inventor: Chunling Wu, Houston, TX (US)

(21) Appl. No.: 18/482,827

(22) Filed: Oct. 6, 2023

(51) Int. Cl. G01V 1/32; G01V 1/28; G01V 1/34

(52) U.S. Cl. CPC G01V 1/325; G01V 1/282; G01V 1/34

(57) ABSTRACT

A method is described for processing distributed acoustic sensing seismic data including receiving, at one or more processors, DAS seismic data, converting the DAS seismic data into pressure data, and processing the pressure data is disclosed. The converting may be done by performing a spatial integral of the DAS seismic data along a DAS cable to get a particle velocity, and performing a spatial derivative of the particle velocity along the DAS cable and a temporal integral to generate the pressure data. The pressure data may then be processed by methods including but not limited to performing reverse time migration to generate a seismic image.

### TECHNICAL FIELD

The disclosed embodiments relate generally to techniques for processing distributed acoustic sensing (DAS) seismic data.

### BACKGROUND

Seismic exploration involves surveying subterranean geological media for hydrocarbon deposits. A survey typically involves deploying seismic sources and seismic sensors at predetermined locations. The sources generate seismic waves, which propagate into the geological medium creating pressure changes and vibrations. Variations in physical properties of the geological medium give rise to changes in certain properties of the seismic waves, such as their direction of propagation and other properties. Alternatively, rather than having active seismic sources to generate seismic waves, a passive seismic survey may use ambient seismic sources such as but not limited to earthquakes, rock fracturing, and/or environmental sources (e.g., vehicle traffic, ocean waves, and the like).

Portions of the seismic waves reach the seismic sensors. Some seismic sensors are sensitive to pressure changes (e.g., hydrophones), others to particle motion (e.g., geophones), and industrial surveys may deploy one type of sensor or both. In response to the detected seismic waves, the sensors generate corresponding electrical signals, known as traces, and record them in storage media as seismic data. Seismic data will include a plurality of “shots” (individual instances of the seismic source being activated), each of which are associated with a plurality of traces recorded at the plurality of sensors.

An alternative seismic sensor may include fiber-optic cables. Fiber-optic cables may be deployed in a borehole drilled through the earth's subsurface, along the earth's surface, or on a seabed. FIG. 1 illustrates a fiber-optic cable 12 attached to an interrogator 10. A laser pulse 14 propagates through the fiber-optic cable 12, shown as light stream 16. The light stream 16 sends information to interrogator 10. An acoustic signal 18 encountering the fiber-optic cable 12 is recorded as a change in strain or strain-rate along the cable and may be considered to be a seismic event. However, conventional methods for processing seismic data are designed for pressure or particle motion data, so may not produce accurate results when processing the DAS seismic data.

Seismic data is processed to create seismic images that can be interpreted to identify subsurface geologic features including hydrocarbon deposits. The ability to define the location of rock and fluid property changes in the subsurface is crucial to our ability to make the most appropriate choices for purchasing materials, operating safely, and successfully completing projects. Project cost is dependent upon accurate prediction of the position of physical boundaries within the Earth. Decisions include, but are not limited to, budgetary planning, obtaining mineral and lease rights, signing well commitments, permitting rig locations, designing well paths and drilling strategy, preventing subsurface integrity issues by planning proper casing and cementation strategies, and selecting and purchasing appropriate completion and production equipment.

There exists a need for methods of processing DAS seismic data.

### SUMMARY

In accordance with some embodiments, a method of receiving, at one or more processors, DAS seismic data, converting the DAS seismic data into pressure data, and processing the pressure data is disclosed. The converting may be done by performing a spatial integral of the DAS seismic data along a DAS cable to get a particle velocity, performing a spatial derivative of the particle velocity along the DAS cable, and performing a temporal integral to generate the pressure data. The pressure data may then be processed by methods including but not limited to performing reverse time migration to generate a seismic image.

In another aspect of the present invention, to address the aforementioned problems, some embodiments provide a non-transitory computer readable storage medium storing one or more programs. The one or more programs comprise instructions, which when executed by a computer system with one or more processors and memory, cause the computer system to perform any of the methods provided herein.

In yet another aspect of the present invention, to address the aforementioned problems, some embodiments provide a computer system. The computer system includes one or more processors, memory, and one or more programs. The one or more programs are stored in memory and configured to be executed by the one or more processors. The one or more programs include an operating system and instructions that when executed by the one or more processors cause the computer system to perform any of the methods provided herein.

### BRIEF DESCRIPTION OF THE DRAWINGS

FIG. 1 illustrates a distributed acoustic sensing (DAS) seismic recording system;

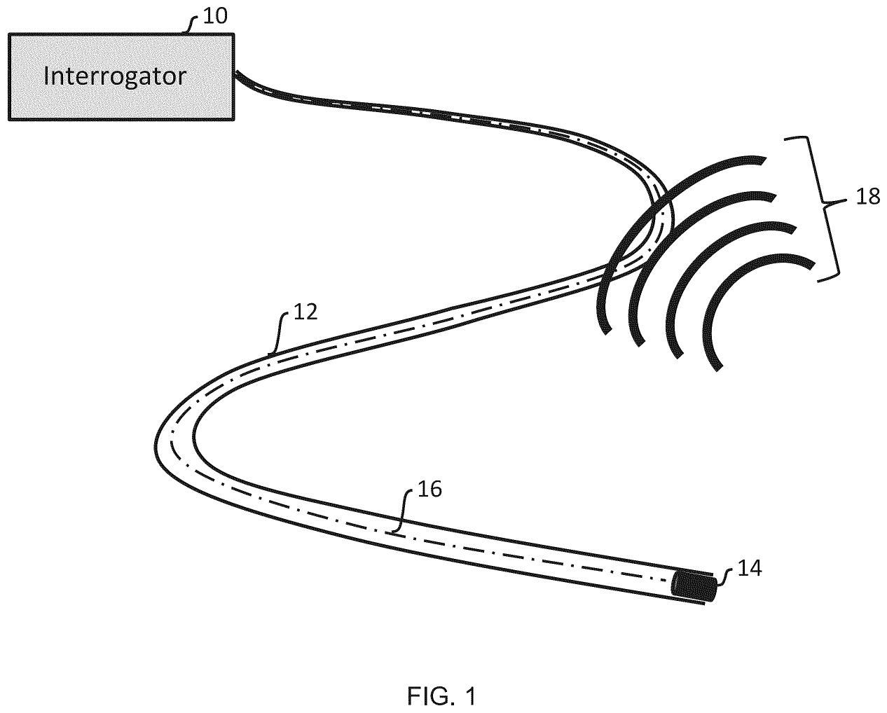

FIG. 2 illustrates an example system for processing DAS seismic data; and

FIG. 3 illustrates an example method for processing DAS seismic data.

Like reference numerals refer to corresponding parts throughout the drawings.

### DETAILED DESCRIPTION OF EMBODIMENTS

Described below are methods, systems, and computer readable storage media that provide a manner of processing distributed acoustic sensing (DAS) seismic data.

Reference will now be made in detail to various embodiments, examples of which are illustrated in the accompanying drawings. In the following detailed description, numerous specific details are set forth in order to provide a thorough understanding of the present disclosure and the embodiments described herein. However, embodiments described herein may be practiced without these specific details. In other instances, well-known methods, procedures, components, and mechanical apparatus have not been described in detail so as not to unnecessarily obscure aspects of the embodiments.

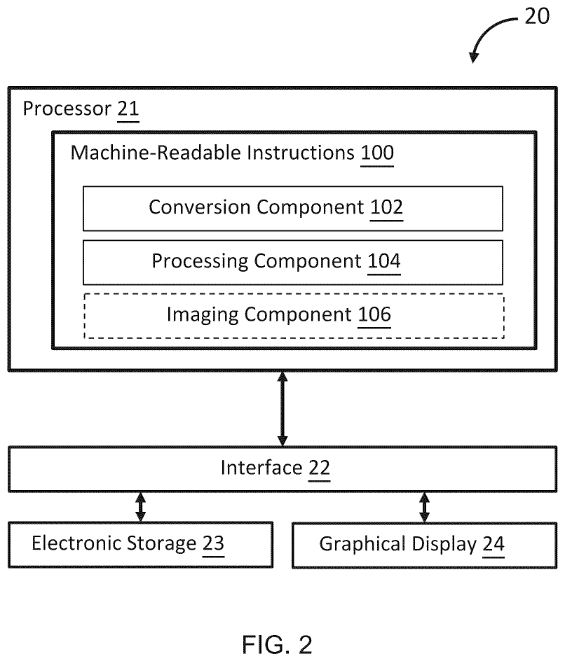

The methods and systems of the present disclosure may be implemented by a system and/or in a system, such as a system 20 shown in FIG. 2. The system 20 may include one or more of a processor 21, an interface 22 (e.g., bus, wireless interface), an electronic storage 23, a graphical display 24, and/or other components.

The electronic storage 23 may be configured to include electronic storage medium that electronically stores information. The electronic storage 23 may store software algorithms, information determined by the processor 21, information received remotely, and/or other information that enables the system 20 to function properly. For example, the electronic storage 23 may store information relating to input DAS seismic data, and/or other information. For example, the electronic storage 23 may store information relating to output processed seismic data, seismic images, and/or other information. The electronic storage media of the electronic storage 23 may be provided integrally (i.e., substantially non-removable) with one or more components of the system 20 and/or as removable storage that is connectable to one or more components of the system 20 via, for example, a port (e.g., a USB port, a Firewire port, etc.) or a drive (e.g., a disk drive, etc.). The electronic storage 23 may include one or more of optically readable storage media (e.g., optical disks, etc.), magnetically readable storage media (e.g., magnetic tape, magnetic hard drive, floppy drive, etc.), electrical charge-based storage media (e.g., EPROM, EEPROM, RAM, etc.), solid-state storage media (e.g., flash drive, etc.), and/or other electronically readable storage media. The electronic storage 23 may include one or more non-transitory computer readable storage medium storing one or more programs. The electronic storage 23 may be a separate component within the system 20, or the electronic storage 23 may be provided integrally with one or more other components of the system 20 (e.g., the processor 21). Although the electronic storage 23 is shown in FIG. 2 as a single entity, this is for illustrative purposes only. In some implementations, the electronic storage 23 may comprise a plurality of storage units. These storage units may be physically located within the same device, or the electronic storage 23 may represent storage functionality of a plurality of devices operating in coordination.

The graphical display 24 may refer to an electronic device that provides visual presentation of information. The graphical display 24 may include a color display and/or a non-color display. The graphical display 24 may be configured to visually present information. The graphical display 24 may present information using/within one or more graphical user interfaces. For example, the graphical display 24 may present information relating to DAS seismic data and processed seismic data, and/or other information.

The processor 21 may be configured to provide information processing capabilities in the system 20. As such, the processor 21 may comprise one or more of a digital processor, an analog processor, a digital circuit designed to process information, a central processing unit, a graphics processing unit, a microcontroller, an analog circuit designed to process information, a state machine, and/or other mechanisms for electronically processing information. The processor 21 may be configured to execute one or more machine-readable instructions 100 to facilitate processing DAS data. The machine-readable instructions 100 may include one or more computer program components. The machine-readable instructions 100 may include a conversion component 102, a processing component 104, an optional imaging component 106, and/or other computer program components.

It should be appreciated that although computer program components are illustrated in FIG. 2 as being co-located within a single processing unit, one or more of computer program components may be located remotely from the other computer program components. While computer program components are described as performing or being configured to perform operations, computer program components may comprise instructions which may program processor 21 and/or system 20 to perform the operation.

While computer program components are described herein as being implemented via processor 21 through machine-readable instructions 100, this is merely for ease of reference and is not meant to be limiting. In some implementations, one or more functions of computer program components described herein may be implemented via hardware (e.g., dedicated chip, field-programmable gate array) rather than software. One or more functions of computer program components described herein may be software-implemented, hardware-implemented, or software and hardware-implemented.

Referring again to machine-readable instructions 100, the conversion component 102 may be configured to convert the DAS seismic data that was recorded as strain or strain-rate to pressure data.

The processing component 104 may be configured to process the converted pressure data using conventional seismic processing methods.

The optional imaging component 106 may be configured to perform seismic imaging of the processed data.

The description of the functionality provided by the different computer program components described herein is for illustrative purposes, and is not intended to be limiting, as any of computer program components may provide more or less functionality than is described. For example, one or more of computer program components may be eliminated, and some or all of its functionality may be provided by other computer program components. As another example, processor 21 may be configured to execute one or more additional computer program components that may perform some or all of the functionality attributed to one or more of computer program components described herein.

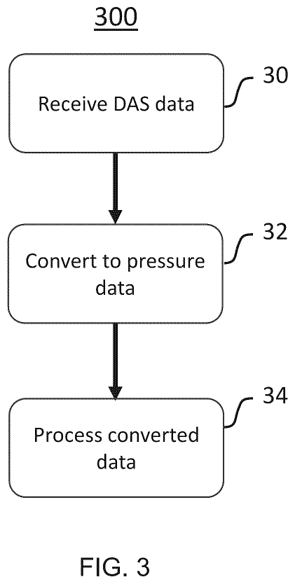

FIG. 3 illustrates an example process 300 for processing DAS seismic data. At step 30, the method receives the distributed acoustic sensing (DAS) seismic data. This data was recorded in response to changes in strain and/or strain-rate along the fiber-optic cable.

At step 32, the DAS seismic data is converted to pressure data, to emulate data that would be recorded by hydrophones rather than by fiber-optics. This may be done, for example, by
Do spatial integral of DAS measured strain-rate εₗ(l) along the DAS cable to get the particle velocity along the DAS cable νₗ.

$${v}_{l} ( l + 1 / 2 ) = {\int }_{l}^{l + 1} {ε}_{l} ( l ) dl \qquad ( l )$$

Take the space derivative of particle velocity (νₗ) along the DAS cable obtained from (1) and do temporal integral to get the pressure field (p)

$$p ( l ) = - K \int \frac{{v}_{l} ( l + 1 / 2 ) - {v}_{l} ( l - 1 / 2 )}{dl} dt \qquad ( 2 )$$

where K is bulk modulus.

At step 34, the converted data can then be processed using any conventional seismic processing. For example, the converted data may be used as input to perform reverse time migration (RTM) to get a subsurface image.

The processed seismic data from step 34 may optionally be used to perform seismic imaging to produce a seismic image of the subsurface.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

The terminology used in the description of the invention herein is for the purpose of describing particular embodiments only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including.” “comprises,” and/or “comprising.” when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting.” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for processing distributed acoustic sensing (DAS) seismic data, comprising:
a. receiving, at one or more processors, DAS seismic data;
b. converting, via the one or more processors, the DAS seismic data into pressure data; and
c. processing the pressure data.

2. The method of claim 1 wherein the converting comprises performing a spatial integral of the DAS seismic data along a DAS cable to get a particle velocity, and performing a spatial derivative of the particle velocity along the DAS cable and a temporal integral to generate the pressure data.

3. The method of claim 2 wherein performing the spatial integral of the DAS seismic data εₗ(l) along the DAS cable to get the particle velocity νₗ. is done by:
$${v}_{l} ( l + 1 / 2 ) = {\int }_{l}^{l + 1} {ε}_{l} ( l ) dl .$$
and the performing the spatial derivative of the particle velocity along the DAS cable and the temporal integral to get a pressure field (p) is done by:
$$p ( l ) = - K \int \frac{{v}_{l} ( l + 1 / 2 ) - {v}_{l} ( l - 1 / 2 )}{dl} dt .$$
where K is bulk modulus.

4. The method of claim 1 wherein the processing is performing reverse time migration with the pressure data as input to generate a seismic image of a subsurface volume of interest.

5. A computer system, comprising:
one or more processors;
memory; and
one or more programs, wherein the one or more programs are stored in the memory and configured to be executed by the one or more processors, the one or more programs including instructions that when executed by the one or more processors cause the system to:
a. receive, at the one or more processors, DAS seismic data;
b. convert, via the one or more processors, the DAS seismic data into pressure data; and
c. process the pressure data.

6. The computer system of claim 5 wherein the instructions to convert the DAS seismic data into pressure data comprise performing a spatial integral of the DAS seismic data along a DAS cable to get a particle velocity, and performing a spatial derivative of the particle velocity along the DAS cable and a temporal integral to generate the pressure data.

7. The computer system of claim 6 wherein performing the spatial integral of the DAS seismic data εₗ(l) along the DAS cable to get the particle velocity νₗ. is done by:
$${v}_{l} ( l + 1 / 2 ) = {\int }_{l}^{l + 1} {ε}_{l} ( l ) dl .$$
and the performing the spatial derivative of the particle velocity along the DAS cable and the temporal integral to get a pressure field (p) is done by:
$$p ( l ) = - K \int \frac{{v}_{l} ( l + 1 / 2 ) - {v}_{l} ( l - 1 / 2 )}{dl} dt .$$
where K is bulk modulus.

8. The computer system of claim 5 wherein the instructions to process the pressure data comprise performing reverse time migration with the pressure data as input to generate a seismic image of a subsurface volume of interest.

9. A non-transitory computer readable storage medium storing one or more programs, the one or more programs comprising instructions, which when executed by an electronic device with one or more processors and memory, cause the device to
a. receive, at one or more processors, DAS seismic data;
b. convert, via the one or more processors, the DAS seismic data into pressure data; and
c. process the pressure data.

10. The non-transitory computer readable storage medium of claim 9 wherein the instructions to convert the DAS seismic data into pressure data comprise performing a spatial integral of the DAS seismic data along a DAS cable to get a particle velocity, and performing a spatial derivative of the particle velocity along the DAS cable and a temporal integral to generate the pressure data.

11. The non-transitory computer readable storage medium of claim 10 wherein performing the spatial integral of the DAS seismic data εₗ(l) along the DAS cable to get the particle velocity νₗ. is done by:
$${v}_{l} ( l + 1 / 2 ) = {\int }_{l}^{l + 1} {ε}_{l} ( l ) dl .$$
and the performing the spatial derivative of the particle velocity along the DAS cable and the temporal integral to get a pressure field (p) is done by:
$$p ( l ) = - K \int \frac{{v}_{l} ( l + 1 / 2 ) - {v}_{l} ( l - 1 / 2 )}{dl} dt .$$
where K is bulk modulus.

12. The non-transitory computer readable storage medium of claim 9 wherein the instructions to process the pressure data comprise performing reverse time migration with the pressure data as input to generate a seismic image of a subsurface volume of interest.
